(19) United States
(12) Patent Application Publication
(10) Pub. No.: US 2023/0043880 A1
(43) Pub. Date: Feb. 9, 2023

(54) TARGET VELOCITY VECTOR DISPLAY SYSTEM, AND TARGET VELOCITY VECTOR DISPLAY METHOD AND PROGRAM

(71) Applicant: NEC Corporation, Tokyo (JP)

(72) Inventor: Hisashi SHIBA, Tokyo (JP)

(73) Assignee: NEC Corporation, Tokyo (JP)

(21) Appl. No.: 17/872,412

(22) Filed: Jul. 25, 2022

(30) Foreign Application Priority Data
Jul. 28, 2021 (JP) 2021-123497

(51) Int. Cl. G01S 15/58; G01S 7/56; G01S 15/66

(52) U.S. Cl. CPC G01S 15/586; G01S 7/56; G01S 15/66

(57) ABSTRACT

A system including a transmitter and a receiver array at a location different from that of a transmitter, virtually divides the receiver array into plural sub-arrays, calculate Doppler coefficients based on movement of a target for the sub-arrays, calculates a velocity vector of a target, by using the Doppler coefficients calculated for the sub-arrays, and display velocity vector of the target.

### FIELD

### Cross Reference to Related Applications

This application is based upon and claims the benefit of the priority of Japanese patent application No. 2021-123497, filed on Jul. 28, 2021, the disclosure of which is incorporated herein in its entirety by reference thereto.

The present invention relates to a target velocity vector display system, and target velocity vector display method and program.

### BACKGROUND

Generally speaking, an active sonar in which a transmission sound source (transmitter) and a reception sensor (receiver) are provided in different places is called “bistatic sonar” or “multistatic sonar.” It is sometimes referred to as “bistatic active sonar” or “multistatic active sonar.” A sonar with a single reception sensor is often termed as bistatic, while a sonar with a plurality of reception sensors, the number thereof not limited to two, termed as multistatic. However, sometimes there is no clear distinction. Therefore, the term “bistatic/multistatic sonar” is used hereinafter.

In an active sonar that transmits a signal (sound wave) and detects an echo from a target, it is very important to obtain and display a line-of-sight velocity of the target. The same is a case with bistatic/multistatic sonar as well. It is, however, not possible to obtain a line-of-sight velocity of a target from a signal received by a reception sensor. This will be described with reference to FIG. 1.

In FIG. 1, a sound source is provided in a transmitter 11, and a receiver 10 includes a reception sensor with a plurality of acoustic elements arranged in an array. The acoustic element converts a received signal (sound wave) to an electric signal for output.

Let vₛ denote a velocity of the transmitter 11 (a magnitude of a velocity vector 14),

vₜ a velocity of a target 12 (a magnitude of a velocity vector 15),

θ_{S} an angle between a velocity vector 14 of the transmitter 11 and a straight line 16 which connects the target 12 and the transmitter 11,

α an angle between the velocity vector 15 of the target 12 and the straight line 16, and

c a sound velocity.

Assuming that the transmitter 11 transmits a PCW (Pulsed Continuous Wave) with a constant frequency f_{c}, a frequency fₛ of a signal (sound wave) received by the transmitter 11 is, in consideration of Doppler effect, given by the following Equation (1):

$${f}_{s} = {f}_{c} \frac{c + {v}_{t} cos α}{c + {v}_{s} cos {θ}_{s}} \cdot \frac{c - {v}_{s} cos {θ}_{s}}{c - {v}_{t} cos α} \qquad ( 1 )$$

That is, letting v₁ denote a velocity component of the transmitter 11 along a direction of the target 12 from the transmitter 11 (for example, the value of v₁ becomes positive as the transmitter 11 approaches the target 12) and v₂ a velocity component of the target 12 along a direction of the transmitter 11 (the value of v₂ becomes positive as the target 12 moves away from the transmitter 11), a frequency f₁ of a signal (sound wave) received by the target 12 from the transmitter 11 is given by the following equation:

$${f}_{1} = {f}_{c} \frac{c - {v}_{2}}{c - {v}_{1}} \qquad ( 2 )$$

Conversely, in a case where the transmitter 11 receives a signal (sound wave) reflected from the target 12, with a direction from the target 12 which is a signal source, to the transmitter 11 being positive, letting v₁′ and v₂′ denote the velocity components of the target 12 and the transmitter 11 along this direction, respectively, a frequency fₛ at the transmitter 11 receiving a reflected signal from the target 12 is given by the following equation:

$${f}_{s} = {f}_{1} \frac{c - {v}_{2}^{′}}{c - {v}_{1}^{′}} \qquad ( 3 )$$

In Equation (3), by substituting v₁′=−v₂, and v₂′=−v₁ into Equation (3) and substituting f₁ with Equation (2), we obtain the following Equation (4).

$${f}_{s} = {f}_{c} \frac{c + {v}_{1}}{c + {v}_{2}} \cdot \frac{c - {v}_{2}}{c - {v}_{1}} \qquad ( 4 )$$

In FIG. 1, with a direction from the transmitter 11 to the target 12 being positive, when the velocity component v₁=−vscos θ_{S} of the transmitter 11 and the velocity component v₂=−vₜ cos α of the target 12 are substituted into Equation (4), Equation (1) is derived.

The coefficient multiplied to the frequency f_{c} on a right side of Equation (1) is called a “Doppler coefficient.” The Doppler coefficient η of a signal (sound wave) received by the transmitter 11 is given by Equation (5).

$$η = \frac{c + {v}_{t} cos α}{c + {v}_{s} cos {θ}_{s}} \cdot \frac{c - {v}_{s} cos {θ}_{s}}{c - {v}_{t} cos α} \qquad ( 5 )$$

It is noted that for an arbitrary function waveform f(t), the Doppler effect on a received waveform, appears as f(ηt) with time multiplied by the Doppler coefficient η. For example, let's assume that a transmission waveform is an LFM (Linear Frequency Modulation) where frequency changes linearly.

$${S}_{t} ( t ) = B \cdot exp \{ if ( t ) \} = B \cdot exp ( j {ω}_{0} t + \frac{1}{2} j μ {t}^{2} ) \qquad ( 6 )$$

An angular frequency ω of a transmission signal at a time t is as follows:

$$\frac{d}{dt} f ( t ) = \frac{d}{dt} ( {ω}_{0} t + \frac{1}{2} μ {t}^{2} ) = {ω}_{0} + μ t \qquad ( 7 )$$

The angular frequency increases linearly from ω₀ at t=0 to ω₀+μL at t=L. This frequency change is repeated at a repetition period L.

Assuming that a time between from transmission of a signal to reception by the receiver 10 (receiver array) of a signal reflected from the target 12 is t₀, a waveform Sr(t) of the received signal is expressed as a waveform in which f(jt) in Equation (1) is replaced with f(jη(t−t₀)) (refer to Patent Literatures 2 and 3).

$${S}_{r} ( t ) = \cdot A \sqrt{η} exp \{ if ( η ( t - {t}_{0} ) ) \} = A \sqrt{η} exp \{ j ω \cdot η ( t - {t}_{0} ) + \frac{1}{2} j μ \cdot {{η}^{2} ( t - {t}_{0} )}^{2} \} \qquad ( 8 )$$

In Patent Literature 3, for the waveform Sr(t) of a signal received presently and the waveform Sᵣ(t−t_{A}) of a signal received a time t_{A} before the present time

$${S}_{r} ( t - {t}_{A} ) = \cdot A \sqrt{η} exp \{ j ω \cdot η ( t - {t}_{0} - {t}_{A} ) + \frac{1}{2} j μ \cdot {{η}^{2} ( t - {t}_{0} - {t}_{A} )}^{2} \} \qquad ( 9 )$$

the product Sᵣ(t) Sᵣ*(t−t_{A}) of the complex conjugates thereof is derived.

$${S}_{r} ( t ) {S}_{r}^{*} ( t - {t}_{A} ) = {\vert A \vert}^{2} η exp \{ j ω \cdot η {t}_{A} + \frac{j μ \cdot {η}^{2} ( 2 {t}_{A} t - {t}_{A}^{2} )}{2} \} \qquad ( 10 )$$

In Equation (10), a term in which a phase depends on time in Sᵣ(t) Sᵣ*(t−t_{A}) is μ·η²t_{A}t, and the product signal has a constant signal waveform with an angular frequency of |μ·η²t_{A}t|. Therefore, a frequency f such that |μ·η²t_{A}t|=2πf is derived from the frequency spectrum of Sᵣ(t) Sᵣ*(t−t_{A}), and the Doppler coefficient η is calculated from

$$η = \sqrt{\frac{2 π \vert f \vert}{\vert μ {t}_{A} \vert}} \qquad ( 11 )$$

Further, according to the disclosure of Patent Literature 2, for a time derivative waveform obtained by differentiating by time the waveform Sᵣ(t) of a received signal

$${S}_{r}^{′} ( t ) = \frac{{dS}_{r} ( t )}{dt}$$

and the waveform of the received signal Sᵣ(t), the absolute value of the ratio therebetween is calculated

$$R ( t ) = \vert \frac{{S}_{r}^{′} ( t )}{{S}_{r} ( t )} \vert \qquad ( 12 )$$

and the Doppler shift η is estimated by fitting an instantaneous frequency of the transmitted waveform to the absolute value R(t) of the ratio between the time derivative waveform and the received waveform, by using a least squares method or the like.

From Equation (5), which expresses the Doppler coefficient η for a signal (sound wave) received by the transmitter 11, the line-of-sight velocity vₜ cos α of the target 12 as viewed from the transmitter 11 (the projection of the velocity vector 15 onto the straight line 16 connecting the transmitter 11 and the target 12) is given by the following Equation (13):

$${v}_{t} cos α = \frac{\{ ( η - 1 ) c + ( η + 1 ) {v}_{s} cos {θ}_{s} \} c}{\{ ( η + 1 ) c + ( η - 1 ) {v}_{s} cos {θ}_{s} \}} \qquad ( 13 )$$

When vₛ, vₜ<<c (vₛ and vₜ are sufficiently smaller than the sound velocity c), Equation (5) becomes as follows:

$$η = \{ \frac{1 + \frac{{v}_{t} cos α}{c}}{1 + \frac{{v}_{s} cos {θ}_{s}}{c}} \} \cdot \{ \frac{1 - \frac{{v}_{s} cos {θ}_{s}}{c}}{1 - \frac{{v}_{t} cos α}{c}} \} ≅ \{ ( 1 + \frac{{v}_{t} cos α}{c} ) \cdot ( 1 - \frac{{v}_{s} cos {θ}_{s}}{c} ) \} \cdot \{ ( 1 - \frac{{v}_{s} cos {θ}_{s}}{c} ) \cdot ( 1 + \frac{{v}_{t} cos α}{c} ) \} = {( 1 + \frac{{v}_{t} cos α}{c} )}^{2} \cdot {( 1 - \frac{{v}_{s} cos {θ}_{s}}{c} )}^{2} ≅ ( 1 + 2 \frac{{v}_{t} cos α}{c} ) \cdot ( 1 - 2 \frac{{v}_{s} cos {θ}_{s}}{c} ) ≅ 1 + \frac{2 ( {v}_{t} cos α - {v}_{s} cos {θ}_{s} )}{c} \qquad ( 14 )$$

$$∴ η ≅ 1 + \frac{2 ( {v}_{t} cos α - {v}_{s} cos {θ}_{s} )}{c}$$

From Equation (14), the line-of-sight velocity vₜ cos α of the target 12 is calculated (approximated) by the following Equation (15):

$${v}_{t} cos α ≅ \frac{c}{2} ( η - 1 ) + {v}_{s} cos {θ}_{s} \qquad ( 15 )$$

The frequency f₁ of the signal received by the target 12 from the transmitter 11 is given by Equation (2). When the direction from the target 12 to the receiver 10 is positive in a straight line 17 from the target 12 to the receiver 10 (FIG. 1) and the velocity components of the target 12 and the receiver 10 in this direction are v₂′ and v₃, respectively, the frequency fᵣ at the receiver 10 receiving a reflected signal from the target 12 is given by the following Equation (16):

$${f}_{r} = {f}_{1} \frac{c - {v}_{3}}{c - {v}_{2}^{′}} = {f}_{c} \frac{c - {v}_{3}}{c - {v}_{2}^{′}} \cdot \frac{c - {v}_{2}}{c - {v}_{1}} \qquad ( 16 )$$

When the velocity component of the transmitter 11 in the direction of the target 12: v₁=−vₛ cos θ_{S},

the velocity component of the target 12 in the direction of the transmitter 11: v₂=−vₜ cos α,

the velocity component of the target 12 in the direction of the receiver 10: v₂′=vₜ cos β(vₜ cos β<0 in FIG. 1), and

the velocity component of the receiver 10 in the direction of the target 12: v₃=vᵣ cos θᵣ (vᵣ cos θᵣ<0 in FIG. 1) are substituted in Equation (16), the following Equation (17) is obtained:

$${f}_{r} = {f}_{c} \frac{c + {v}_{t} cos α}{c + {v}_{s} cos {θ}_{s}} \cdot \frac{c - {v}_{r} cos {θ}_{r}}{c - {v}_{t} cos β} \qquad ( 17 )$$

Therefore, the Doppler coefficient ηᵣ of a signal (sound wave) received by the receiver 10 is given by Equation (18).

$${η}_{r} = \frac{c + {v}_{t} cos α}{c + {v}_{s} cos {θ}_{s}} \cdot \frac{c - {v}_{r} cos {θ}_{r}}{c - {v}_{t} cos β} \qquad ( 18 )$$

When vₛ, vₜ, vᵣ «c, Equation (18) can be approximated as follows:

$${η}_{r} = \{ \frac{1 + \frac{{v}_{t} cos α}{c}}{1 + \frac{{v}_{s} cos {θ}_{s}}{c}} \} \cdot \{ \frac{1 - \frac{{v}_{r} cos {θ}_{r}}{c}}{1 - \frac{{v}_{t} cos β}{c}} \} ≅ \{ ( 1 + \frac{{v}_{t} cos α}{c} ) \cdot ( 1 - \frac{{v}_{s} cos {θ}_{s}}{c} ) \} \cdot \{ ( 1 - \frac{{v}_{r} cos {θ}_{r}}{c} ) \cdot ( 1 + \frac{{v}_{t} cos β}{c} ) \} = ( 1 + \frac{{v}_{t} cos α}{c} ) \cdot ( 1 + \frac{{v}_{t} cos β}{c} ) \cdot ( 1 - \frac{{v}_{s} cos {θ}_{s}}{c} ) \cdot ( 1 - \frac{{v}_{r} cos {θ}_{r}}{c} ) ≅ ( 1 + \frac{{v}_{t} cos α + {v}_{t} cos β}{c} ) \cdot ( 1 - \frac{{v}_{s} cos {θ}_{s} + {v}_{r} cos {θ}_{r}}{c} ) ≅ 1 + \frac{{v}_{t} cos α + {v}_{t} cos β - {v}_{s} cos {θ}_{s} - {v}_{r} cos {θ}_{r}}{c} \qquad ( 19 )$$

$$∴ {η}_{r} ≅ 1 + \frac{{v}_{t} cos α + {v}_{t} cos β - {v}_{s} cos {θ}_{s} - {v}_{r} cos {θ}_{r}}{c}$$

Both Equation (18) and (19) have vₜ cos as an unknown variable, in addition to vₜ cos α to be derived. Even if the Doppler coefficient ηᵣ of a signal (sound wave) received by the receiver 10 is obtained by measuring the received signal and vₛ cos θ_{S} and vᵣ cos θᵣ are given by position and velocity sensors of the transmitter 11 and the receiver 10, each of Equation (18) and (19) is an equation with two variables vₜ cos α and vₜ cos β, and no solution can be obtained in principle.

Patent Literature 1 describes bistatic active sonar in which a transmitter and a receiver are provided in different locations on the same ship and their velocity is the same, i.e., vₛ=vᵣ=v, and by using the following approximation:

vₜ cos α=vₜ cos β=m,

there is only one variable.

Further, in Patent Literature 1, the target direction from the transmitter is calculated by using the trigonometric law of cosines with respect to a triangle having the transmitter (transmitter array), the receiver (receiver array), and the target as vertices. Further, the distance from the transmitter to the target and the distance from the target to the receiver are calculated using the distance between the transmitter and the receiver, the time it takes for a signal transmitted from the transmitter to be received by the receiver via the target position, the underwater sound velocity, and the target direction obtained by a phase adjuster in the receiver.

In Patent Literature 1, Equation (18) becomes Equation (20) below.

$${η}_{r} = \frac{c + m}{c - m} \cdot \frac{c - v cos {θ}_{r}}{c + v cos {θ}_{s}} \qquad ( 20 )$$

From Equation (20), the target's line-of-sight velocity m can be given by Equation (21).

$$m = \frac{{η}_{r} c ( c + v cos {θ}_{s} ) - c ( c - v cos {θ}_{r} )}{{η}_{r} ( c + v cos {θ}_{s} ) + ( c - v cos {θ}_{r} )} \qquad ( 21 )$$

Note that, although Patent Literature 1 calls m the “absolute velocity,” v is normally called the absolute velocity.

Further, in Equation (18), θᵣ, and θ_{S}, are the angle formed by a velocity vector 13 of the receiver 10 with respect to the straight line 17 connecting the target 12 and the receiver 11 and the angle formed by the velocity vector 14 of the transmitter 11 with respect to the straight line 16 connecting the target 12 and the transmitter 11, respectively. In Patent Literature (PTL) 1, θᵣ, and θ_{S} denote directions of the target with respect to the transmitter and the receiver based on a straight line connecting the transmitter and the receiver, and in an equation (Equation (5)) of Patent Literature 1, the + and − of “c−vcos θᵣ” and “c+vcos θ_{S}” in Equation (20) above are reversed.

The following analyzes the approximation in Patent Literature 1

vₜ cos α=vₜ cos β=m

This part

cos α=cos β,

i.e., in FIG. 1, the angle α formed by the velocity vector 15 of the target 12 with respect to the straight line 16 connecting the transmitter 11 and the target 12 is equal to the angle β formed by the velocity vector 15 of the target 12 with respect to the straight line 17 connecting the receiver 10 and the target 12. Therefore, the angle Θ formed by the two straight lines 16 and 17 is zero. This condition holds only when the distances between the target 12 and the transmitter 11 and the receiver 10 are much greater than the distance between the transmitter 11 and the receiver 10.

For example, letting A denote the distance between the transmitter 11 and the target 12, B the distance between the receiver 10 and the target 12, and C the distance between the transmitter 11 and the receiver 10, as illustrated in FIG. 2, the following Equation (22) holds from the trigonometric law of cosines:

$$cos Θ = \frac{{A}^{2} + {B}^{2} - {C}^{2}}{2 AB} \qquad ( 22 )$$

If Θ=0, then cos Θ=1. For example, if C=1 kyd (kiloyard) and A=B=10 kyd in Equation (22), cos Θ=0.995.

This appears to be sufficiently approximated to 1, but Θ≅5.73 deg.

In FIG. 1, for example, β=α+Θ=85.73 deg when α=80 deg,

then,

cos α≅0.174, cos β≅0.074

and

cos α≠cos β.

In a case where the distance A between the transmitter 11 and the target 12 and the distance B between the receiver 10 and the target 12 are close to the distance C between the transmitter 11 and the receiver 10, for example,

if A=B=C=1 kyd,

cos Θ=0.5, i.e., Θ=60 deg.

If α=80 deg, then β=α+Θ=140 deg.

Then,

cos α≅0.174, cos β≅−0.766,

resulting in very different cos α and cos β.

At this time, if vₛ=vᵣ=0 kt (knot) and

α=80 deg, β=140 deg, vₜ=10 kt,

then

m≅−2.97 kt.

This is clearly different from vₜ cos β≅−7.66 kt expected by the receiver 10.

In other words, Patent Literature 1 uses the approximation based on a premise that does not hold depending on the conditions, and one may not be able to obtain the target's line-of-sight velocity accurately.

A method that is not restricted by such conditions is the one described in Non-Patent Literature 1, the disclosure of which is outlined here. The notation is different, but the essence thereof is as follows.

In Non-Patent Literature (NPL) 1, the target's line-of-sight velocity as viewed from the transmitter is calculated based on a signal received by a sensor (receiver array) of the transmitter according to Equation (13), which is listed again as below:

$${v}_{t} cos α = \frac{\{ ( η - 1 ) c + ( η + 1 ) {v}_{s} cos {θ}_{s} \} c}{\{ ( η + 1 ) c + ( η - 1 ) {v}_{s} cos {θ}_{s} \}} \qquad ( 13 )$$

Next, the Doppler coefficient ηᵣ of the target 12 as viewed from the receiver 10 is derived from a signal received by a sensor (receiver array) of the receiver 10.

Then, the line-of-sight velocity vₜ cos β of the target 12 as viewed from the receiver 1Θ can be derived by substituting vₜ cos α obtained by Equation (13) above into Equation (19) derived from Equation (18).

$${v}_{t} cos β = c - \frac{c + {v}_{t} cos α}{c + {v}_{s} cos {θ}_{s}} \cdot \frac{c - {v}_{r} cos {θ}_{r}}{{η}_{r}} \qquad ( 23 )$$

Here, from FIG. 1, since

α=β−Θ holds,

vₜ cos α=vₜ cos(β−Θ)=vₜ cos β cos Θ+vₜ sin β sin Θ (24)

vₜ cos α is obtained by using Equation (13) and vₜ cos β₁s obtained by using Equation (23).

Θ can be derived if the distance A from the transmitter 11 to target 12, the distance B from the receiver 10 to the target 12, and the distance C between the transmitter 11 and the receiver 1Θ can be known from Equation (22).

An active sonar system is an apparatus that obtains a distance to and a direction of the target 12. With respect to the distance C between the transmitter 11 and the receiver 10, if the transmitter 11 and the receiver 10 are mounted on the same ship, their positions can be obtained, for example, from dimensions indicated in the design of the ship. Even when the transmitter 11 and the receiver 10 are mounted on different ships and separated from each other, location information can be exchanged, for example, using the GPS (Global Positioning System). When the ship with the receiver 10 is towed by another ship with the transmitter 11, the position of the receiver 1Θ can be known from an attitude sensor of the receiver 10. Therefore, vₜ sin β can be derived by the following Equation (25):

$${v}_{t} sin β = \frac{{v}_{t} cos α - {v}_{t} cos βcos Θ}{sin Θ} \qquad ( 25 )$$

As described above, each of vₜ cos β and vₜ sin βΘ can be obtained. In other words, the two-dimensional (2-D) target→velocity vector 15 is calculated, not a scalar such as a line-of-sight velocity (velocity component) of the target 12. A velocity vector is obviously much more useful than a line-of-sight velocity.

In addition to utilizing Equation (22) as described above, Θ can be derived if the angle formed by the target 12 and the receiver 10 as viewed from the transmitter 11, the distance to the target 12 as viewed from the transmitter 11, and the distance between the transmitter 11 and the receiver 10 are known. Alternatively, Θ can also be obtained by using the angle formed by the target 12 and the transmitter 11 as viewed from the receiver 10, the distance to the target 12 as viewed from the receiver 10, and the distance between the transmitter 11 and the receiver 10.
[PTL 1] Japanese Patent Kokai Publication No. 2017-106748A
[PTL 2] International Publication No. WO2018/038128
[PTL 3] Japanese Patent Kokai Publication No. 2019-23577A
[NPL 1] Pascal A. M. de Theije and Jean-Christophe Sindt, “Single-Ping Target Speed and Course Estimation Using a Bistatic Sonar,” IEEE Journal of Oceanic Engineering, Vol. 31, No. 1, January 2006
[NPL 2] Shiba, “A New Integration-System based Doppler Velocity Estimation Method,” Marine Acoustics Society of Japan, 2020 Research Presentations, Proceedings of Lectures, p. 55.
[NPL 3] Shiba, “Target Direction Estimation Using Phase Difference Between Sub-arrays and Time Shift Difference,” Ultrasonic Technology, 2020. 1-2, Vol. 32, No. 1, pp. 28-33

### SUMMARY

In Non-Patent Literature 1, it is assumed that the transmitter is also capable of receiving a signal reflected from the target using a reception sensor. In a sonar system, however, the transmitter may be dedicated to transmission only and may not have a reception function. For example, in a variable depth sonar (VDS) in which the transmitter and the receiver are towed by a ship, the transmitter is generally dedicated to transmission.

In a case of CAS (Continuous Active Sonar) in which continuous transmission is performed, signals are always transmitted. Therefore, even with a transmitter having a reception function, if acoustic elements for both transmission and reception are used, it is not possible to receive a signal. In CAS, the acoustic elements are separated for transmission and reception, and even if the transmitter is capable of receiving signals, short range reverberation is so large that saturation may occur. As a result, it is not possible to identify an echo from a target in a received signal.

Therefore, it is an object of the present invention to provide a system, method and non-transitory medium storing a program, each capable of deriving and displaying a velocity vector of a target, even in a case where a transmitter is not able to receive a signal reflected from the target in, for example, a bistatic/multistatic sonar system.

According to the present invention, there is provided a target velocity vector display system comprising:

a transmitter that transmits a transmission signal;

a receiver array including a plurality of receiver elements arranged in an array form, the receiver array provided at a location different from a location of the transmitter, the receiver array receiving a reflection signal from a target that reflects the transmission signal transmitted from the transmitter,

a display apparatus; and

at least one processor configured to:

virtually divide the receiver array into a plurality of sub-arrays;

calculate an individual Doppler coefficient based on movement of the target for an individual one of the plurality of sub-arrays;

calculate a velocity vector of the target, by using a plurality of the individual Doppler coefficients calculated respectively for the plurality of sub-arrays; and

display, on the display apparatus, information on the velocity vector of the target.

According to the present invention, there is provided a target velocity vector display method for a sonar system including a transmitter that transmits a transmission signal; and a receiver array including a plurality of receiver elements arranged in an array form, the receiver array provided at a location different from a location of the transmitter, the receiver array receiving a reflection signal from a target that reflects the transmission signal transmitted from the transmitter, the method comprising

virtually dividing the receiver array into a plurality of sub-arrays;

calculating an individual Doppler coefficient based on movement of the target for an individual one of the plurality of sub-arrays;

calculating a velocity vector of the target, by using a plurality of the individual Doppler coefficients calculated respectively for the plurality of sub-arrays; and

displaying, on a display apparatus, information on the velocity vector of the target.

According to the present invention, there is provided a non-transitory computer readable medium storing a program causing a computer constituting a sonar system including a transmitter that transmits a transmission signal; and a receiver array including a plurality of receiver elements arranged in an array form, the receiver array provided at a location different from a location of the transmitter, the receiver array receiving a reflection signal from the target reflecting the transmission signal transmitted from the transmitter, to execute processing comprising

virtually dividing the receiver array into a plurality of sub-arrays;

calculating an individual Doppler coefficient based on movement of the target for an individual one of the plurality of sub-arrays;

calculating the velocity vector of the target, by using a plurality of the individual Doppler coefficients calculated respectively for the plurality of sub-arrays; and

displaying, on a display apparatus, information on the velocity vector of the target.

According to the present invention, even in a system where a transmitter is not able to receive a signal reflected from a target, a velocity vector of the target can be derived and displayed.

### BRIEF DESCRIPTION OF THE DRAWINGS

FIG. 1 is a diagram illustrating the velocities of a transmitter, a receiver and a target, and a Doppler coefficient.

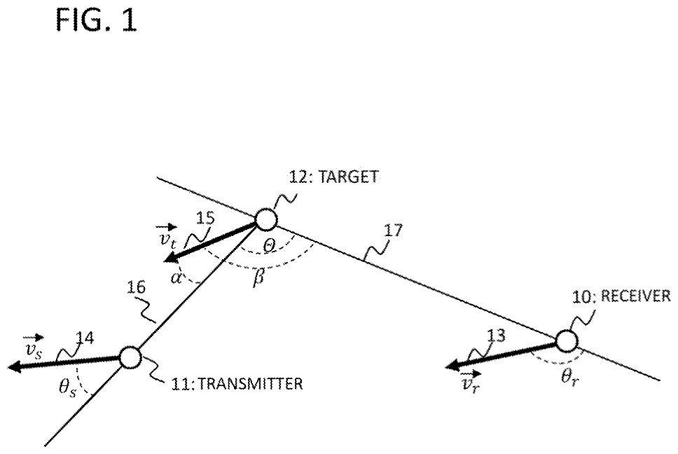

FIG. 2 is a diagram illustrating the velocities of the transmitter, the receiver and the target, and the Doppler coefficient.

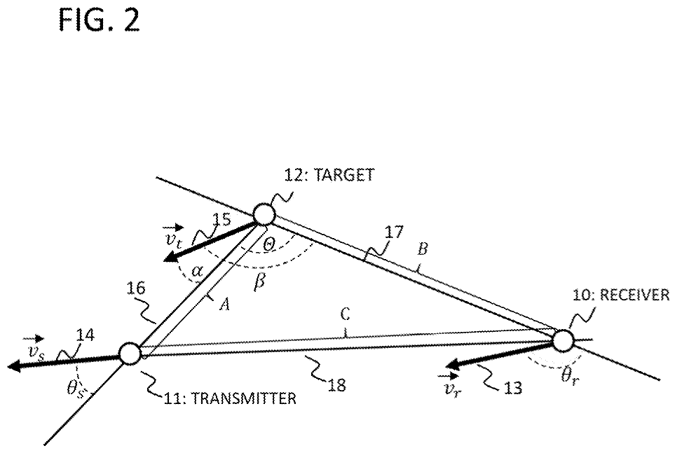

FIG. 3A is a diagram illustrating a transmitter/receiver array, FIGS. 3B and 3C are diagrams illustrating sub-arrays.

FIG. 4 is a diagram illustrating configuration of a first example embodiment of the present invention.

FIG. 5 is a diagram illustrating a variation of the configuration of the first example embodiment of the present invention.

FIG. 6 is a diagram illustrating the first example embodiment of the present invention.

FIG. 7 is a diagram illustrating the first example embodiment of the present invention.

FIG. 8 is a diagram illustrating configuration of a second example embodiment of the present invention.

FIG. 9 is a diagram illustrating configuration of the second example embodiment of the present invention.

FIG. 10 is a diagram illustrating configuration of a third example embodiment of the present invention.

FIG. 11 is a diagram illustrating the third example embodiment of the present invention.

FIG. 12 is a diagram illustrating an example of an apparatus configuration of the present invention.

### DETAILED DESCRIPTION

Example Embodiments of the present invention will be described. According to the present invention, in bistatic or multistatic sonar in which a transmission source and a reception sensor are separated, a reception sensor of a receiver (or reception sensors of a plurality of receivers) is virtually divided into at least first and second sub-arrays, first and second Doppler coefficients are calculated, respectively, from a received signal received by at least the first and the second sub-arrays, for each of the first and the second Doppler coefficients, the velocity vector of the target is calculated from an equation that holds between the Doppler coefficients, a signal velocity, position and velocity of the target, the position and velocity of the transmission source, and the position and velocity of each of the sub-arrays or from a set of simultaneous equations using an approximate expression, and the velocity vector of the target is displayed on a display apparatus.

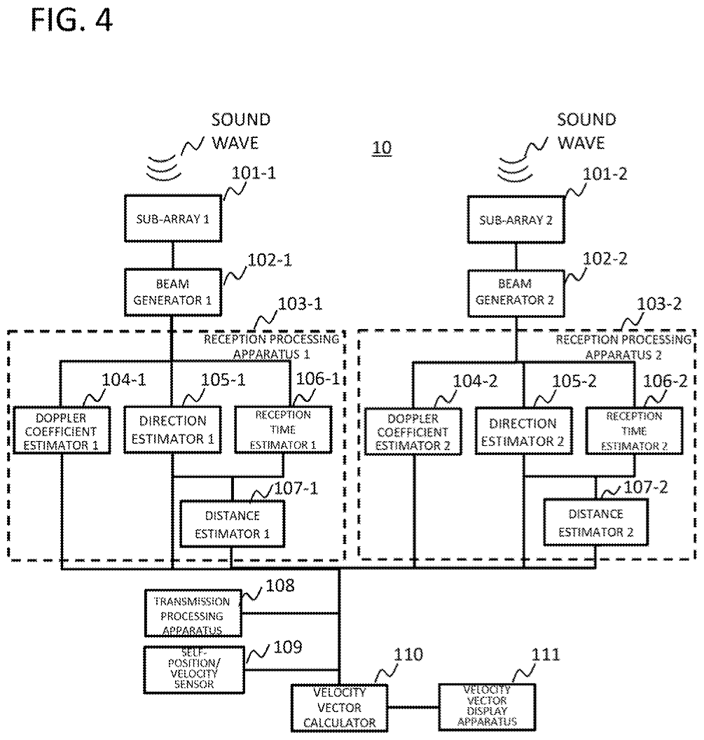

FIG. 4 is a diagram illustrating configuration of an example embodiment of the present invention, wherein there are two sub-arrays. A system that displays a target velocity vector includes a first sub-array 101-1, a second sub-array 101-2, a first beam generator 102-1, a second beam generator 102-2, a first reception processing apparatus 103-1, a second reception processing apparatus 103-2, a transmission processing apparatus 108, a self-position/velocity sensor 109, a velocity vector calculator 110, and a velocity vector display apparatus 111.

The first reception processing apparatus 103-1 includes a first Doppler coefficient estimator 104-1, a first direction estimator 105-1, a first reception time estimator 106-1, and a first distance estimator 107-1.

The second reception processing apparatus 103-2 includes a second Doppler coefficient estimator 104-2, a second direction estimator 105-2, a second reception time estimator 106-2, and a second distance estimator 107-2.

In FIG. 4, the first sub-array to the first distance estimator are written as sub-array 1 to distance estimator 1, respectively, and the second sub-array to the second distance estimator are written as sub-array 2 to distance estimator 2, respectively. In the following description, these elements are referred to using the notation in the diagram, such as sub-array 1, 2, etc., when it is clear without a description using reference numbers.

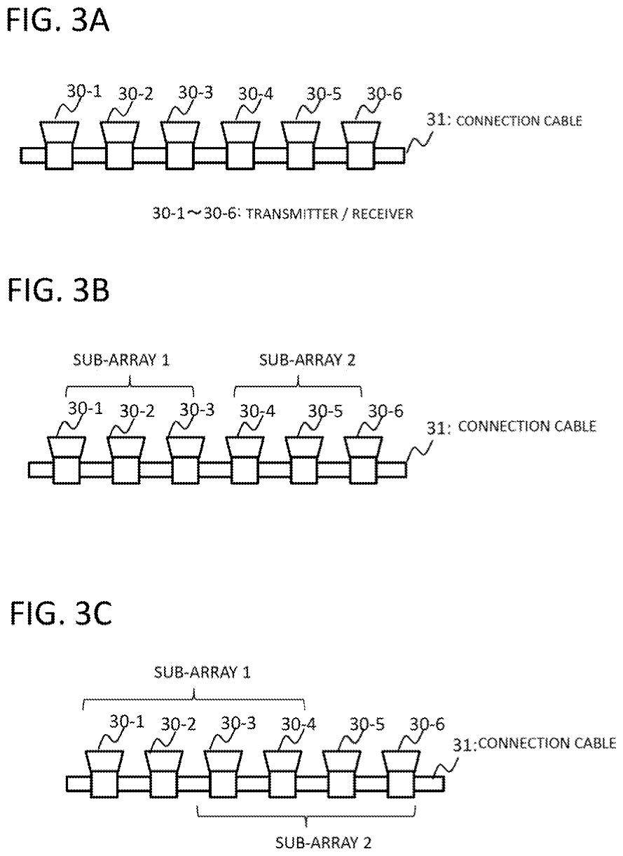

As a method for virtually dividing an array in which transmitters/receivers (acoustic elements that convert a transmission signal received as an electrical signal to an acoustic signal for transmission, and convert a received acoustic signal to an electrical signal) are arranged in a straight line, as illustrated in FIG. 3A, into two sub-arrays, for example, the transmitters/receivers may be divided into two different groups as illustrated in FIG. 3B, or they may be divided so that some transmitters/receivers belong to both groups, as illustrated in FIG. 3C. Virtual division part that each sub-array is processed as a separate entity in signal processing without physically disconnecting the array.

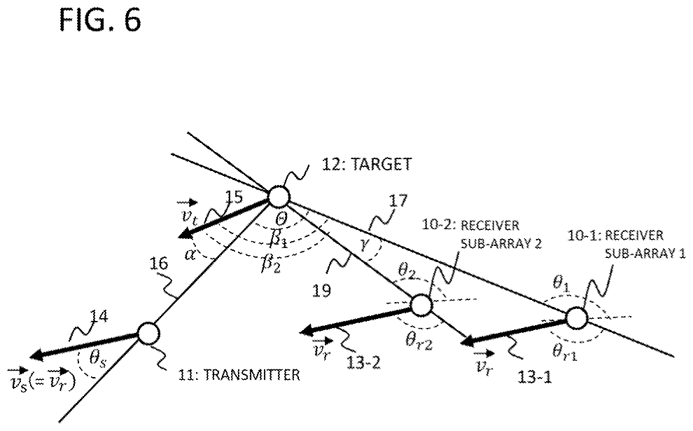

An operation of the present example embodiment will be described with reference to FIGS. 6 and 4. The following description assumes that the transmitter 11 and the receiver 10 are mounted on the same ship. For example, as the transmitter 11, transmitters/receivers (or wave receivers) may be fixedly mounted on a hull of the ship (hull sonar) or the transmitters/receivers (or receivers) may be fixedly mounted on a bow of the ship (bow sonar). Alternatively, a towed sound source may be used. The receiver 10 may be attached to a side of the ship (flank array), or it may be towed from a stern of the ship (towed array).

In this case, as illustrated in FIG. 6, a velocity vector 14 (→vₛ) of the transmitter 11 is equal to velocity vectors 13-1 and 13-2 (→vᵣ) of the sub-arrays 1 and 2 of the receiver 10 (the vectors have the same magnitude and direction).

Here, it is assumed that the first and the second sub-arrays 101-1 and 101-2 in FIG. 4 (corresponding to a receiver sub-array 1 (10-1) and a receiver sub-array 2 (10-2) in FIG. 6) are configured, for example, as illustrated in FIG. 3B or 3C. Sound waves received at the first sub-array 101-1 are subjected to phasing-processing by the first beam generator 102-1. Sound waves received at the second sub-array 101-2 are subjected to phasing-processing by the second beam generator 102-2.

In FIG. 4, the first and the second Doppler coefficient estimators 104-1 and 104-2 estimate first and second Doppler coefficients ηᵣ₁ and ηᵣ₂ at the first and the second sub-arrays 101-1 and 101-2. The first and second Doppler coefficients ηᵣ₁ and ηᵣ₂ may be estimated from the signals received by the first and the second sub-arrays 101-1 and 101-2, using a signal waveform Sᵣ(t) received by each sub-array and a method described in Non-Patent Literature 2, in addition to the methods of Patent Literatures 2 and 3, examples of which were outlined using Equation (11) and (12) listed above, though not limited thereto.

The first and the second direction estimators 105-1 and 105-2 estimate a direction of the target as viewed from each sub-array.

As the method for estimating a direction of the target 12, for example, one can employ a commonly used method in which all directions are scanned with a beam and the target is determined to be in a direction in which a reflection intensity increases. Alternatively, as described in Non-Patent Literature 3, the sub-arrays 1 and 2 may be further divided into a plurality of sub-arrays and a target direction may be estimated from phase among the sub-arrays. In addition, there are various commonly used techniques such as an adaptive phasing processing (adaptive beamforming) and a compressed sensing.

In FIG. 4, the first and the second reception time estimators 106-1 and 106-2 obtain a time at each of the first and the second sub-arrays 101-1 and 101-2, between when the transmitter 11 transmits a signal and when an echo from the target 12 is received. For example, with signals (sound waves) being continuously received, a time when a received signal (sound wave) exceeds a threshold value is deemed to be a reception time and a signal (sound wave) from the target is determined to have arrived. As for the transmission time, for example, time information with respect to when the transmitter transmits a signal is obtained from the transmitter. The reception time interval is obtained by subtracting a time when the signal is transmitted from a time when the echo is received. The method for obtaining the reception time is, as a matter of course, not limited to this, and various known methods may be used.

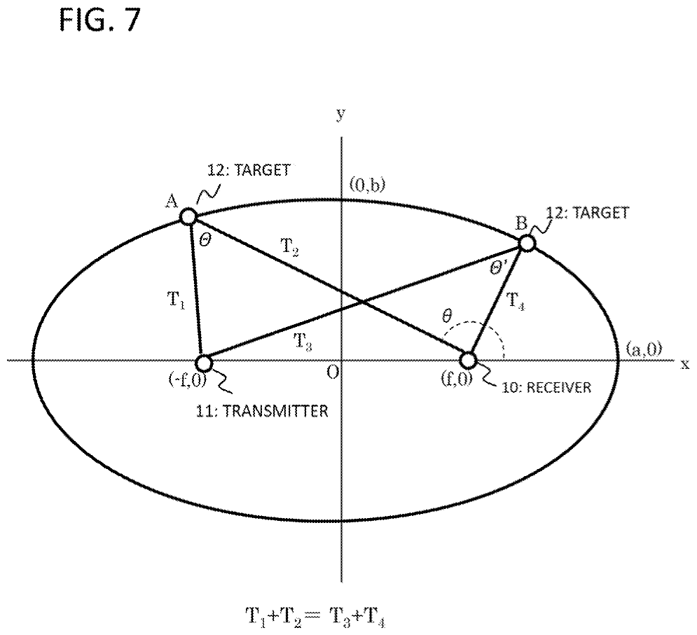

The first and the second distance estimators 107-1 and 107-2 estimate distances (target distances) between the target 12 and the first and the second sub-arrays 101-1 and 101-2, respectively. In bistatic/multistatic sonar, when an echo from the target 12 arrives after a constant time after the transmission time, a position of the target 12 is on an ellipse, as illustrated in FIG. 7.

In FIG. 7, T₁ (T₃) is time it takes for a signal transmitted from the transmitter 11 to reach the target 12, and T₂ (T₄) is time it takes for a signal (sound wave) reflected from the target 12 to be received by the receiver 10. In FIG. 7, a focus (+f, 0) of the ellipse is a position of the receiver 10 at a time t₀ (reception time) when a signal (sound wave) reflected from the target 12 is received by the receiver 10, a point A on the ellipse is the position of the target 12 at a time t₀-T₂, and a focus (−f, 0) of the ellipse is a position of the transmitter 11 at a time t₀-T₂-T₁.

It is not possible to obtain a target distance between the receiver 10 (sub-arrays) and the target 12 only from the reception time of an echo at the receiver 10 (sub-arrays). The target distance can be obtained only when a direction (target direction) of the target 12 from the receiver 10 (sub-arrays) is found. Time T₀ from when the transmitter 11 transmits a signal to when an echo reaches the receiver 10 is T₁+T₂. Letting c denote a sound velocity, a sum of respective distances cT₁ and cT₂ from the transmitter 11 and the receiver 10 to the target 12 at the point A, is a length 2a of a major axis of the ellipse. From

$${cT}_{1} + {cT}_{2} = c ( {T}_{1} + {T}_{2} ) = {cT}_{0} = 2 a , \\ a = \frac{{cT}_{0}}{2} \qquad ( 26 )$$

Letting L denote a distance (space) between the transmitter 11 at a position (an ellipse focus (−f, 0)) at a time point when a signal is transmitted (t₀−T₂−T₁) and the receiver 10 at a position (an ellipse focus (+f, 0)) at a time t₀, is L, f=L/2. Assuming that a minor axis length of the ellipse is 2b, then

$$b = \sqrt{{a}^{2} - {f}^{2}} = \sqrt{\frac{{c}^{2} {T}_{0}^{2} - {L}^{2}}{4}} \qquad ( 27 )$$

For example, when the target direction of the target 12 at the point A is θ, the target distance R=cT₂ from the receiver 10 can be derived by substituting the coordinates of the target 12

(x,y)=(cT₂ cos θ+f,cT₂ sin θ)=(cT₂ cos θ+L/2,cT₂ sin θ) (28)

into

$$\frac{{x}^{2}}{{a}^{2}} + \frac{{y}^{2}}{{b}^{2}} = 1 \qquad ( 29 )$$

Note that, in FIG. 7, a target direction may be the supplementary angle of θ.

$$R = {cT}_{2} = \frac{- {b}^{2} L cos θ + \sqrt{{b}^{4} {cos}^{2} θ + 4 ( {b}^{2} {cos}^{2} θ + {a}^{2} {sin}^{2} θ ) \cdot {b}^{2} ( {a}^{2} - \frac{{L}^{2}}{4} )}}{2 ( {b}^{2} {cos}^{2} θ + {a}^{2} {sin}^{2} θ )} = \frac{- {b}^{2} L cos θ + \sqrt{{b}^{4} {cos}^{2} θ + 4 ( {b}^{2} {cos}^{2} θ + {a}^{2} {sin}^{2} θ ) \cdot {b}^{4}}}{2 ( {b}^{2} {cos}^{2} θ + {a}^{2} {sin}^{2} θ )} \qquad ( 30 )$$

For example, the first distance estimator 107-1 (the second distance estimator 107-2) calculates a distance R₁ (R₂) between the first sub-array 101-1 and the target 12 from the distance (space) L between the transmitter 11 at a time point when a signal is transmitted and a position of the first sub-array 101-1 (the second sub-array 101-2) when an echo of the transmission signal reflected from the target 12 is received, a time T₀ from when the signal is transmitted to when the first sub-array 101-1 (the second sub-array 101-2) receives the echo, and a target direction θᵣ₁ (θᵣ₂) from the first sub-array 101-1 (the second sub-array 101-2).

Using Equation (18), a Doppler coefficient ηᵣ₁ of a signal (sound wave) received at the first sub-array 101-1 from the target is given as follows:

$${η}_{r 1} = \frac{c + {v}_{t} cos α}{c + {v}_{s} cos {θ}_{s}} \cdot \frac{c - {v}_{r} cos {θ}_{r 1}}{c - {v}_{t} cos {β}_{1}} \qquad ( 31 )$$

where

vₜ is a magnitude of a velocity of the target 12,

α is an angle formed by a straight line 16 connecting the transmitter 11 to the target 12 and a velocity vector 15 of the target 12,

β is an angle formed by a straight line 17 connecting the first sub-array 101-1 of the receiver 10 to the target 12 and the velocity vector 15 of the target 12,

vₛ is a magnitude of a velocity of the transmitter 11,

θ_{S} is an angle formed by the straight line 16 connecting the transmitter 11 to the target 12 and a velocity vector 14 of the transmitter 11,

vᵣ is a magnitude of a velocity of the first sub-array 101-1, and

θᵣ₁ is an angle formed by the straight line 17 connecting the first sub-array 101-1 of the receiver 10 to the target 12 and a velocity vector 13-1 of the first sub-array 101-1.

From α=β₁−Θ(Θ is a crossing angle between the straight line 16 connecting the transmitter 11 to the target 12 and the straight line 17 connecting the receiver 10 to the target 12),

cos α=cos β₁ cos Θ+sin β₁ sin Θ,

by substituting cos α in Equation (31) with the right side in the above equation, transforming Equation (31), and factoring out the components vₜ cos β₁, vₜ sin β₁ of the 2D velocity vector of the target 12, the following is obtained:

{(c−vᵣ cos Θᵣ₁)cos Θ+ηᵣ₁(c+vₛ cos θ_{S})}vₜ cos β₁+(c−vᵣ cos θᵣ₁)sin Θvₜ sin β₁=cηᵣ₁(c+vₛ cos θ_{S})−c(c−vᵣ cos θᵣ₁)

Here, since a magnitude vₛ of the velocity of the transmitter 11 is equal to a magnitude vᵣ of the velocity of the sub-array 1 of the receiver 10,

vₛ=vᵣ.

Then,

{(c−vᵣ cos θᵣ₁)cos Θ+ηᵣ₁(c+vᵣ cos θ_{S})}vₜ cos β₁+(c−vᵣ cos θᵣ₁)sin Θvₜ sin β₁=cηᵣ₁(c+vᵣ cos θ_{S})−c(c−vᵣ cos θᵣ₁) (32)

The Doppler coefficient ηᵣ₂ of the signal (sound wave) received at the second sub-array 101-2 from the target is given by the following Equation (33):

$${η}_{r 2} = \frac{c + {v}_{t} cos α}{c + {v}_{s} cos {θ}_{s}} \cdot \frac{c - {v}_{r} cos {θ}_{r 2}}{c - {v}_{t} cos {β}_{2}} \qquad ( 33 )$$

where, vₜ, α, vₛ, θ_{S} are the same as those in Equation (31).

β₂ is an angle formed by a straight line 19 connecting the second sub-array 101-2 of the receiver 10 to the target 12 and the velocity vector 15 of the target 12,

vᵣ is a magnitude of the velocity of the second sub-array 101-2, and

θᵣ₂ is an angle formed by the straight line 19 connecting the second sub-array 101-2 of the receiver 10 to the target 12 and the velocity vector 13-2 of the second sub-array 101-2.

From β₂=β₁−γ(γ is a crossing angle between the straight line 17 connecting the first sub-array 101-1 to the target 12 and the straight line 19 connecting the second sub-array 101-2 of the receiver 10 to the target 12) and

α=β₁−Θ,

cos β₂=cos β₁ cos γ+sin β₁ sin γ, and
cos α=cos β₁ cos Θ+sin β₁ sin Θ
By substituting cos β₂ and cos α in Equation (33) with right hand side expression in the above two equations, transforming Equation (33) and factoring out the components (x, y)=(vₜ cos β₁, vₜ sin β₁) of the 2D velocity vector of the target 12, the following is obtained:

{(c−vᵣ cos θᵣ₂)cos Θ+ηᵣ₂(c+vₛ cos θ_{S})cos γ}vₜ cos β₁+{(c−vᵣ cos θᵣ₂)sin Θ+ηᵣ₂(c+vₛ cos θ_{S})sin γ}vₜ sin β₁=cηᵣ₂(c+vₛ cos θ_{S})−c(c−vᵣ cos θᵣ₂)

Here, since the magnitude vₛ of the velocity vector of the transmitter 11 is equal to the magnitude vᵣ of the velocity of the sub-array 2 of the receiver 10, vₛ=vᵣ. Then,

{(c−vᵣ cos θᵣ₂)cos Θ+ηᵣ₂(c+vᵣ cos θ_{S})cos γ}vₜ cos β₁+{(c−vᵣ cos θᵣ₂)sin Θ+ηᵣ₂(c+vᵣ cos θ_{S})sin γ}vₜ sin β₁=cηᵣ₂(c+vᵣ cos θ_{S})−c(c−vᵣ cos θᵣ₂) (34)

Further, the self-position/velocity sensor 109 detects a common velocity vᵣ for the velocity vector 14 of the transmitter 11 and the velocity vectors 13-1 and 13-2 of the two sub-arrays for supply to the velocity vector calculator 110. The self-position/velocity sensor 109 may detect a 2D velocity vector.

By setting

a₁₁=(c−vᵣ cos θᵣ₂)sin Θ+ηᵣ₂(c+vᵣ cos θ_{S})sin γ

a₁₂=(c−vᵣ cos θᵣ₁)sin Θ

b₁=cηᵣ₁(c+vᵣ cos θ_{S})−c(c−vᵣ cos θᵣ₁)

a₂₁=(c−vᵣ cos θᵣ₂)cos Θ+ηᵣ₂(c+vᵣ cos θ_{S})cos γ

a₂₂=(c−vᵣ cos θᵣ₂)sin Θ+ηᵣ₂(c+vᵣ cos θ_{S})sin γ

b₂=cηᵣ₂(c+vᵣ cos θ_{S})−c(c−vᵣ cos θᵣ₂)

from Equation (32) and (34), the following two simultaneous equations are obtained:

a₁₁vₜ cos β₁+a₁₂vₜ sin β₁=b₁

a₂₁vₜ cos β₁+a₂₂vₜ sin β₁=b₂ (35)

From which, the components vₜ cos β₁ and vₜ sin β₁ of the 2D velocity vector 15 of the target 12 are obtained.

In other words, when a 2×2 matrix A and 2D vectors→v, →b are

$$A = ( \begin{matrix}{a}_{11} & {a}_{12} \\ {a}_{21} & {a}_{22}\end{matrix} ) = ( \begin{matrix}\begin{matrix}\{ ( c - {v}_{r} cos {θ}_{r 1} ) cos Θ + \\ {η}_{r 1} ( c + {v}_{r} cos {θ}_{s} ) \}\end{matrix} & ( c - {v}_{r} cos {θ}_{r 1} ) sin Θ \\ \begin{matrix}\{ ( c - {v}_{r} cos {θ}_{r 2} ) cos Θ + \\ {η}_{r 2} ( c + {v}_{r} cos {θ}_{s} ) cos γ \}\end{matrix} & \{ ( c - {v}_{r} cos {θ}_{r 2} ) sin Θ + {η}_{r 2} ( c + {v}_{r} cos {θ}_{s} ) sin γ \}\end{matrix} ) \qquad ( 36 )$$

$$\vec{{v}_{t}} = ( \begin{matrix}{v}_{t} cos {β}_{1} \\ {v}_{t} sin {β}_{1}\end{matrix} ) \qquad ( 37 )$$

$$\vec{b} = ( \begin{matrix}{b}_{1} \\ {b}_{2}\end{matrix} ) = ( \begin{matrix}c {η}_{r 1} ( c + {v}_{r} cos {θ}_{s} ) - c ( c - {v}_{r} cos {θ}_{r 1} ) \\ c {η}_{r 2} ( c + {v}_{r} cos {θ}_{s} ) - c ( c - {v}_{r} cos {θ}_{r 2} )\end{matrix} ) , \qquad ( 38 )$$

Equation (35) can be expressed in the matrix form of Equation (39).

A·\vec{vₜ}=\vec{b} (39)

Therefore,

\vec{vₜ}=A⁻¹·\vec{b} (40)

In other words,

$$\vec{{v}_{t}} = ( \begin{matrix}{v}_{t} cos {β}_{1} \\ {v}_{t} sin {β}_{1}\end{matrix} ) = \frac{1}{{a}_{11} \cdot {a}_{22} - {a}_{12} \cdot {a}_{21}} ( \begin{matrix}{a}_{22} \cdot {b}_{1} - {a}_{12} \cdot {b}_{2} \\ - {a}_{21} \cdot {b}_{1} + {a}_{11} \cdot {b}_{2}\end{matrix} ) . \qquad ( 41 )$$

The velocity vector calculator 110 is able to derive the 2D velocity vector→vₜ=(vₜ cos β₁, vₜ sin β₁) of the target 12 having the direction from the first sub-array 101-1 to the target 12 as the first component and the direction perpendicular (orthogonal) thereto as the second component using:

the Doppler coefficients ηᵣ₁ and ηᵣ₂ at the first and the second sub-arrays 101-1 and 101-2 estimated by the first and the second Doppler coefficient estimators 104-1 and 104-2;

the angle θᵣ₁ formed by the straight line 17 connecting the first sub-array 101-1 to the target 12 and the velocity vector 13-1 of the first sub-array 101-1;

the angle θᵣ₂ formed by the straight line 19 connecting the second sub-array 101-2 to the target 12 and the velocity vector 13-2 of the second sub-array 101-2;

the common velocity vᵣ of the first and the second sub-arrays 101-1 and 101-2; and

the angle θ_{S} formed by the straight line 16 connecting the transmitter 11 to the target 12 and the velocity vector 14 of the transmitter 11. It is noted that a value of the sound velocity c may be provided in advance or may be measured on the spot.

The velocity vector calculator 110 may derive vᵣ cos Θₛ, vᵣ cos Θᵣ₁ and vᵣ cos Θᵣ₂ based on the results of measuring the velocity vectors by the self-position/velocity sensor 109 and the position of the target 12. The velocity vectors→vₛ=→vᵣ₁=→vᵣ₂=→vᵣ of the transmitter 11 and the first and the second sub-arrays 101-1 and 101-2 in, for example, a 2D plane with the east-west direction as the x-axis and the north-south direction as the y-axis may be derived from the measurement results at the self-position/velocity sensor 109, and the projections vᵣ cos θₛ, vᵣ cos Θᵣ₁ and vᵣ cos Θᵣ₂ of the transmitter 11 and the first and the second sub-arrays 101-1 and 101-2 onto the line-of-sight direction of the target may derived by drawing the straight lines 16 and 17 in FIG. 6 from location information of the transmitter 11 and the first and the second sub-arrays 101-1 and 101-2 based on the results measured at a position sensor and the position of the target 12 (calculated from, for example, the direction of and the distance to the target).

The velocity vᵣ of the receiver 10 may be obtained from a velocity sensor attached to the body of the ship or may be calculated based on location information obtained from the GPS (Global Positioning System).

Θ in Equation (36) (a crossing angle Θ between the straight lines 16 and 17 in FIG. 6) can be calculated when positions of the first sub-array 101-1 of the receiver 10, the transmitter 11, and the target 12 are found. In a case where the receiver 10 is mounted on the body of the ship, the position of the first sub-array 101-1 can be determined from a structural location thereof. In a case where the receiver 10 is towed, its position can be estimated from a structural length of a towing portion. Alternatively, a position sensor may be attached to the receiver 10, and the velocity vector calculator 110 may obtain a position of the sub-array 101-1 from the position sensor.

In a case where the transmitter 11 is mounted on the ship, the position thereof can also be found from its structural location. In a case where the transmitter 11 is towed, its position can be estimated from the structural length of the towing portion. Alternatively, a position sensor may be attached to the transmitter 11, and the velocity vector calculator 110 may obtain its position from the position sensor. Further, the transmission processing apparatus 108 in FIG. 4 may obtain, from the transmitter 11, location information thereof for supply to the velocity vector calculator 110.

The velocity vector calculator 110 is able to find a position of the target 12 by using the target directions θ₁ and θ₂ obtained by the first and the second direction estimators 105-1 and 105-2 and the target distances obtained by the first and the second distance estimators 107-1 and 107-2.

γ in Equation (36) (a crossing angle between the straight line 17 connecting the sub-array 1 to the target 12 and the straight line 19 connecting the sub-array 2 to the target 12 in FIG. 6) is a difference in the target direction between the first and the second sub-arrays 101-1 and 101-2. The velocity vector calculator 110 is able to find γ from the first and the second target directions θ₁ and θ₂ obtained by the first and the second direction estimators 105-1 and 105-2 corresponding to the sub-arrays 101-1 and 101-2, respectively, as follows:

θ₁−θ₂=γ (42)

Further, as a non-limiting example, the target direction θ₁ in FIG. 6 may be a direction with respect to a straight line connecting the first sub-array 101-1 of the receiver 10 and the transmitter 11 as illustrated in FIG. 7. The target direction θ₂ from the second sub-array 101-2 may also be a direction with respect to a straight line parallel to this straight line.

Further, in FIG. 6, since the velocity vectors 13-1 and 13-2 of the first and the second sub-arrays 101-1 and 101-2 are the same (parallel), regarding the angle θᵣ₁ formed by the straight line 17 connecting the first sub-array 101-1 to the target 12 and the velocity vector 13-1 of the first sub-array 101-1 and the angle 9r2 formed by the straight line 19 connecting the second sub-array 101-2 to the target 12 and the velocity vector 13-2 of the second sub-array 101-2, the following holds:

θᵣ₁−θᵣ₂=γ (43)

Alternatively, the velocity vector calculator 110 may calculate θ₁, θ₂ and γ by only using the distance L between the first and the second sub-arrays 101-1 and 101-2 and the distances (target distances) R1 and R2 from the first and the second sub-arrays 101-1 and 101-2 to the target 12, using the trigonometric law of cosines, without using γ obtained from the first and the second target directions θ₁ and θ₂ and Equation (42). This is effective when it suffices that a directional accuracy is low.

Further, the Doppler coefficient η at the receiver 10 may be calculated based on the approximate expression (19), instead of Equation (18). In this case, the Doppler coefficient ηᵣ₁ obtained at the sub-array 1 is given by the following equation:

$${η}_{r 1} = 1 + \frac{{v}_{t} ( cos α + cos {β}_{1} ) - {v}_{s} cos {θ}_{s} - {v}_{r} cos {θ}_{r 1}}{c} \qquad ( 44 )$$

From α=β₁−Θ,

cos α=cos β₁ cos Θ+sin β₁ sin Θ,

By substituting cos α in Equation (44) with cos β₁ cos Θ+sin β₁ sin Θ, transforming the equation, and factoring out the components vₜ cos β₁, vₜ sin β₁ of the 2D velocity vector of the target 12, the following is obtained:

(cos Θ+1)vₜ cos β₁+sin Θvₜ sin β₁=c(ηᵣ₁−1)+vₛ cos θₛ+vᵣ cos θᵣ₁

Here, since the magnitude vₛ of the velocity of the transmitter 11 is equal to the magnitude vᵣ of the velocity of the sub-array 1 of the receiver 10, vₛ=vᵣ. Then,

(cos Θ+1)vₜ cos β₁+sin Θvₜ sin β₁=c(ηᵣ₁−1)+vᵣ(cos θ_{S}+cos Θᵣ₁) (45)

The Doppler coefficient ηᵣ₂ obtained at the sub-array 2 is given by Equation (46):

$${η}_{r 2} = 1 + \frac{{v}_{t} \{ cos α + cos {β}_{1} cos γ + sin {β}_{1} sin γ \} - {v}_{s} cos {θ}_{s} - {v}_{r} cos {θ}_{r 2}}{c} \qquad ( 46 )$$

From β₂=β₁−γ,

α=β₁−Θ,

substitute cos β₂=cos β₁ cos γ+sin β₁ sin γ,

cos α=cos β₁ cos Θ+sin β₁ sin Θ

By substituting cos β2 and cos α in Equation (46) with

cos β₁ cos γ+sin β₁ sin γ and cos β₁ cos Θ+sin β₁ sin Θ,

transforming the equation, and

factoring out the components vₜ cos β₁ and vₜ sin β₁ of the 2D velocity vector of the target 12, the following is obtained:

(cos Θ+cos γ)vₜ cos β₁+(sin Θ+sin γ)vₜ sin β₁=c(ηᵣ₂−1)+vₛ cos θₛ+vᵣ cos θᵣ₂

Here, since the magnitude vₛ of the velocity of the transmitter 11 is equal to the magnitude vᵣ of the velocity of the sub-array 2 of the receiver 10, vₛ=vᵣ. Then,

(cos Θ+cos γ)vₜ cos β₁+(sin Θ+sin γ)vₜ sin β₁=c(ηᵣ₂−1)+vᵣ(cos θ_{S}+cos θₛ+cos θᵣ₂) (47)

From the two simultaneous equations (45) and (47), the components vₜ cos β₁ and vₜ sin β₁ of the 2D velocity vector of the target 12 are calculated. That is, as for a 2×2 matrix F and 2D vectors→vₜ and →g in the following Equation (48) to (50), Equation (51) holds:

$$F = ( \begin{matrix}cos Θ + 1 & sin Θ \\ cos Θ + cos γ & sin Θ + sin γ\end{matrix} ) \qquad ( 48 )$$

$$\vec{{v}_{t}} = ( \begin{matrix}{v}_{t} cos {β}_{1} \\ {v}_{t} sin {β}_{1}\end{matrix} ) \qquad ( 49 )$$

$$\vec{g} = ( \begin{matrix}c ( {η}_{r 1} - 1 ) + {v}_{r} ( cos {θ}_{s} + cos {θ}_{r 1} ) \\ c ( {η}_{r 2} - 1 ) + {v}_{r} ( cos {θ}_{s} + cos {θ}_{r 2} )\end{matrix} ) \qquad ( 50 )$$

$$F \cdot \vec{{v}_{t}} = \vec{g} \qquad ( 51 )$$

Therefore, from

\vec{vₜ}=F⁻¹·\vec{g} (52)

the 2D velocity vector→vₜ of the target 12 is calculated.

The velocity vector display apparatus 111 may display the 2D velocity vector→vₜ of the target 12 calculated by the velocity vector calculator 110 in association with the direction of and the distance to the target and the time on the display apparatus.

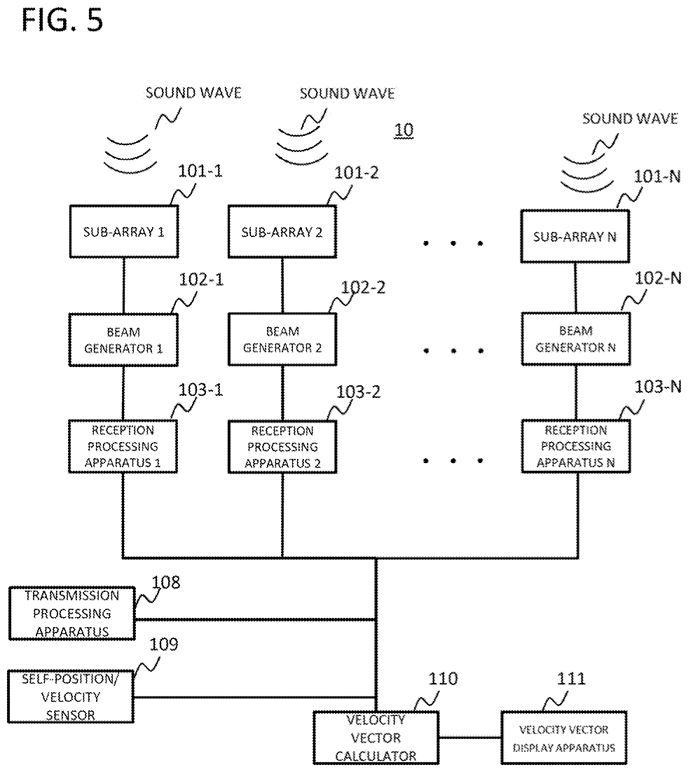

In the present example embodiment, an array is divided into two sub-arrays, however, a single array may be divided into three or more sub-arrays as illustrated in FIG. 5. In this case, for example, a velocity vector of a target may be calculated by using the Doppler coefficients η obtained for a combination of any two sub-arrays, an arithmetic mean of target velocity vectors each obtained from each combination may be calculated as the velocity vector of the target 12.

The example embodiment described above assumes that the transmitter 11 and the receiver 10 are mounted on the body of the same ship, or the receiver 10 is towed by the ship, and that the transmitter 11 and the receiver 10 have the same velocity.

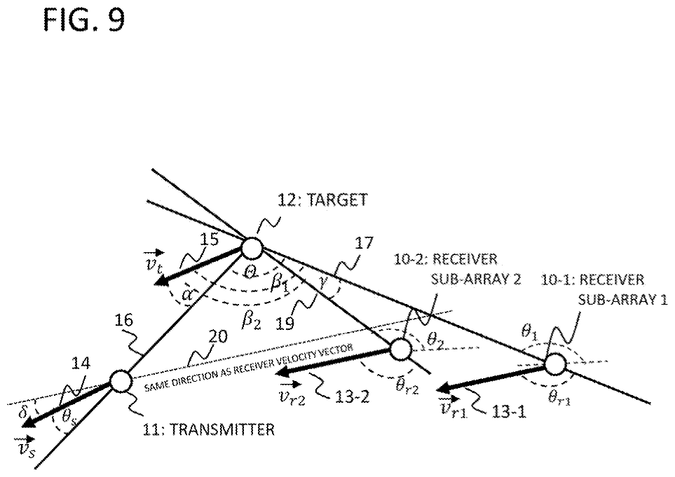

However, even when the transmitter 11 and the receiver 10 are separated and have different velocities, it is possible to calculate the 2D velocity vector of the target 12. In this case, for example, for the transmitter 11 may be a hull sonar, bow sonar, or towed sound source in which the transmitter 11 is mounted on a ship different from the one on which the receiver 10 is mounted, and the receiver 10 may be a hull sonar, bow sonar, flank array sonar (placed along a flank of the hull of a submarine with array elements integrated in a plate shape) or towed array in which the receiver 10 is mounted on a ship different from the one on which the transmitter 11 is mounted. In this case, the transmitter 11 and the receiver 10 (sub-arrays) have different velocity vectors, as illustrated in FIG. 9.

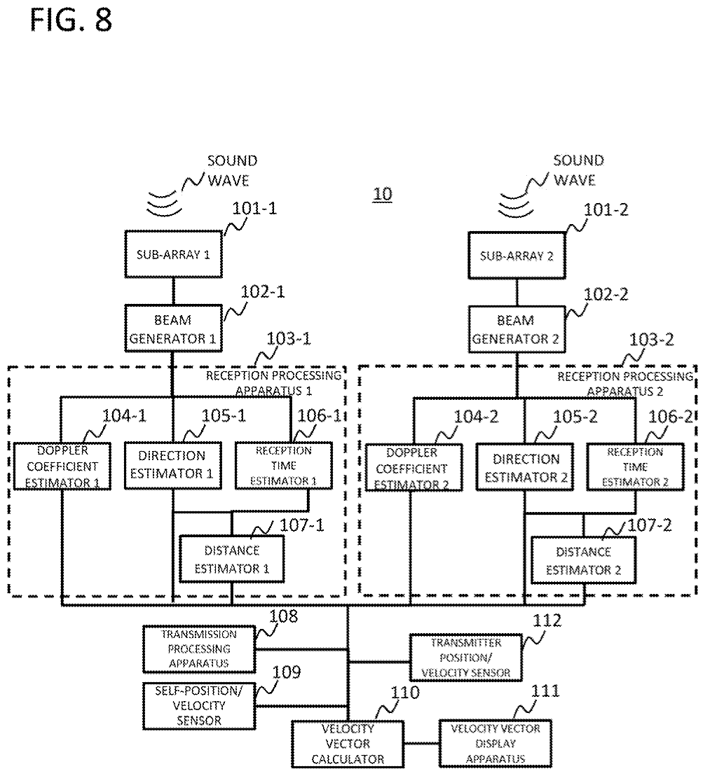

FIG. 8 is a diagram illustrating a configuration example of a target velocity vector display system of a second example embodiment of the present invention. In this example, the receiver 10 is divided into two sub-arrays 1 and 2. Unlike the first example embodiment in which the velocity vector 13 of the receiver 10 is equal to the velocity vector 14 of the transmitter 11, a transmitter position/velocity sensor 112 is added in the present example embodiment.

Position/velocity data of the transmitter 11 obtained by the transmitter position/velocity sensor 112 is transmitted from the transmitter 11 to the receiver 10 via, for example, communication part, which may be a wireless LAN (Local Area Network) or optical communication if the transmitter 11 and the receiver 10 are close to each other. When the distance therebetween is long, wireless or satellite communication may be used. Alternatively, the transmitter 11 may send the data to the receiver 10 via underwater acoustic communication, or even in a case of ordinary sonar where the transmitter 11 does not have a communication function, data may be transmitted by utilizing various modulation techniques including frequency modulation and phase modulation.

The following describes a method for deriving the velocity vector of the target 12 when the transmitter 11 and the receiver 10 have different velocities. Using Equation (18), the Doppler coefficient ηᵣ₁ of a signal (sound wave) received at the first sub-array 101-1 of the receiver 10 from the target is given as follows:

$${η}_{r 1} = \frac{c + {v}_{t} cos α}{c + {v}_{s} cos {θ}_{s}} \cdot \frac{c - {v}_{r} cos {θ}_{r 1}}{c - {v}_{t} cos {β}_{1}} \qquad ( 53 )$$

By using α=β₁−Θ, Equation (53) is transformed as follows:

{(c−vᵣ cos θᵣ₁)cos Θ+ηᵣ₁(c+vₛ cos Θₛ)}vₜ cos β₁+sin Θ(c−vᵣ cos θᵣ₁)vₜ sin β₁=cηᵣ₁(c+vₛ cos θ_{S})−c(c−vᵣ cos θᵣ₁) (54)

The Doppler coefficient ηᵣ₂ of a signal (sound wave) received at the sub-array 2 from the target can also be given from Equation (18) as follows:

$${η}_{r 2} = \frac{c + {v}_{t} cos α}{c + {v}_{s} cos {θ}_{s}} \cdot \frac{c - {v}_{r} cos {θ}_{r 2}}{c - {v}_{t} cos {β}_{2}} \qquad ( 55 )$$

From

β₂=β₁−γ

α=β₁−Θ,

{(c−vᵣ cos θᵣ₂)cos Θ+ηᵣ₂(c+vₛ cos θₛ)cos γ}vₜ cos β₁+{(c−vᵣ cos θᵣ₂)sin Θ+ηᵣ₂(c+vₛ cos θₛ)sin γ}vₜ sin β₁ Equation (55) is transformed as follows:

=cηᵣ₂(c+vₛ cos θₛ)−c(c−vᵣ cos θᵣ₂) (56)

Therefore, if

$$A = ( \begin{matrix}\{ ( c - {v}_{r} cos {θ}_{r 1} ) cos Θ + {η}_{r 1} ( c + {v}_{s} cos {θ}_{s} ) \} & ( c - {v}_{r} cos {θ}_{r 1} ) sin Θ \\ \{ ( c - {v}_{r} cos {θ}_{r 2} ) cos Θ + {η}_{r 2} ( c + {v}_{s} cos {θ}_{s} ) cos γ \} & \{ ( c - {v}_{r} cos {θ}_{r 2} ) sin Θ + {η}_{r 2} ( c + {v}_{s} cos {θ}_{s} ) sin γ \}\end{matrix} ) \qquad ( 57 )$$

$$\vec{{v}_{t}} = ( \begin{matrix}{v}_{t} cos {β}_{1} \\ {v}_{t} sin {β}_{1}\end{matrix} ) \qquad ( 58 )$$

$$\vec{b} = ( \begin{matrix}c {η}_{r 1} ( c + {v}_{s} cos {θ}_{s} ) - c ( c - {v}_{r} cos {θ}_{r 1} ) \\ c {η}_{r 2} ( c + {v}_{s} cos {θ}_{s} ) - c ( c - {v}_{r} cos {θ}_{r 2} )\end{matrix} ) \qquad ( 59 )$$

Equation (54) and (56) can be expressed in the matrix form of the following Equation (60):

A·\vec{vₜ}=\vec{b} (60)

Therefore, with

\vec{vₜ}=A⁻¹·\vec{b} (61)

vₜ cos β₁ and vₜ sin β₁ can be calculated. Since the velocity magnitude vₜ and the angle β₁ are derived, the 2D velocity vector 15 of the target 12 can be calculated. Here, the sound velocity c may be provided in advance or may be measured on the spot. The velocity vector→vᵣ of the receiver 10 may be obtained from a velocity sensor attached to the body of the ship or may be calculated from location information obtained from the GPS and the like.

In Equation (57), Θ is the crossing angle between the straight line 16 connecting the transmitter 11 to the target 12 and the straight line 17 connecting the receiver 10 to the target 12 and can be calculated if the positions of the sub-array 101-1, the transmitter 11, and the target 12 are known. In a case where the receiver 10 is mounted on the body of the ship, the position of the first sub-array 101-1 can be determined from the structural location thereof. In a case where the receiver 10 is towed, its position can be estimated from the structural length of the towing portion. A position sensor may be attached to the receiver 10, and the position of the sub-array 101-1 may be obtained from the position sensor.

As for the position and velocity of the transmitter 11, for example, data from the position/velocity sensor provided in the transmitter 11 may be sent to the receiver 10 via communication part as stated above. The transmission processing apparatus 108 may receive from the transmitter 11 the position and velocity thereof and provide the information to the velocity vector calculator 110.

The position of the target 12 can be derived by using the target direction θ₁ obtained by the first direction estimator 105-1 and the target distance R1 obtained by the first distance estimator 107-1.

Since γ is the difference in the direction between the first and the second sub-arrays 101-1 and 101-2, it can be derived from the target directions θ₁, θ₂ obtained by the first and the second direction estimators 105-1 and 105-2 corresponding to each of the sub-arrays as follows:

θ₁−θ₂=γ (62)

Further, for example, the target direction θ₁ in FIG. 6 may be the direction with respect to the straight line connecting the first sub-array 101-1 of the receiver 10 and the transmitter 11 as illustrated in FIG. 7, without being particularly limited thereto. The target direction θ₂ from the second sub-array 101-2 may also be the direction with respect to a straight line parallel to this straight line.

Further, from FIG. 9, regarding an angle θᵣ₁ formed by the straight line 17 connecting the first sub-array 101-1 to the target 12 and the velocity vector 13-1 of the first sub-array 101-1 and an angle 9r2 formed by the straight line 19 connecting the second sub-array 101-2 to the target 12 and the velocity vector 13-2 of the second sub-array 101-2, the following holds:

θᵣ₁−θᵣ₂=γ (63)

Alternatively, θ₁, θ₂, and γ may be calculated and derived by only using the distance R between the first and the second sub-arrays 101-1 and 101-2 and the target distances from the first and the second sub-arrays 101-1 and 101-2 without using the target directions θ₁, θ₂ and γ obtained from θ₁ and θ₂, and the results may be used. This is effective when the directional accuracy suffices to be low.

Further, the approximate expression (19) may be used instead of Equation (18). In this case, the Doppler coefficient ηᵣ₁ obtained at the first sub-array 101-1 is given as follows:

$${η}_{r 1} = 1 + \frac{{v}_{t} ( cos α + cos {β}_{1} ) - {v}_{s} cos {θ}_{s} - {v}_{r} cos {θ}_{r 1}}{c} \qquad ( 64 )$$

Using α=β₁−Θ, Equation (64) is transformed as follows:

{(cos Θ+1)}vₜ cos β₁+(sin Θ)vₜ sin β₁=c(ηᵣ₁−1)+vₛ cos θₛ+vᵣ cos θᵣ₁ (65)

The Doppler coefficient ηᵣ₂ obtained at the second sub-array 101-2 is given as follows:

$${η}_{r 2} = 1 + \frac{{v}_{t} \{ cos α + cos {β}_{2} cos γ + sin {β}_{2} sin γ \} - {v}_{s} cos {θ}_{s} - {v}_{r} cos {θ}_{r 2}}{c} \qquad ( 66 )$$

From

β₂=β₁−γ,

α=β₁−Θ,

Equation (66) is transformed as follows:

{(cos Θ+cos γ)}vₜ cos β₁+{(sin Θ+sin γ)}vₜ sin β₁=c(ηᵣ₂−1)+v_{S} cos θₛ+vᵣ cos θᵣ₂ (67)

Here, when assuming

$$F = ( \begin{matrix}cos Θ + 1 & sin Θ \\ cos Θ + cos γ & sin Θ + sin γ\end{matrix} ) \qquad ( 68 )$$

$$\vec{{v}_{t}} = ( \begin{matrix}{v}_{t} cos {β}_{1} \\ {v}_{t} sin {β}_{1}\end{matrix} ) \qquad ( 69 )$$

$$and$$

$$\vec{g} = ( \begin{matrix}c ( {η}_{r 1} - 1 ) + {v}_{s} cos {θ}_{s} + {v}_{r} cos {θ}_{r 1} \\ c ( {η}_{r 2} - 1 ) + {v}_{s} cos {θ}_{s} + {v}_{r} cos {θ}_{r 2}\end{matrix} ) \qquad ( 70 )$$

then

F·\vec{vₜ}=\vec{g} (71)

and from

\vec{vₜ}=F⁻¹·\vec{g} (72)

the 2D velocity vector→vₜ of the target 12 is calculated.

The velocity vector display apparatus 111 may display the 2D velocity vector→vₜ of the target 12 calculated by the velocity vector calculator 110 in association with the direction of and the distance to the target and the time on the display apparatus.

It is noted that, although an array is divided into two sub-arrays in the case described above, it may be divided into three or more sub-arrays as in the first example. In this case, for example, the velocity vectors obtained from combinations of any two sub-arrays may be averaged among the combinations.

In the example embodiment described above, the sub-arrays of the receiver 10 are obtained by virtually dividing a single sensor, however, the velocity vector of the target 12 can also be derived from physically independent sub-arrays. In this case, for example, sonar systems mounted on a plurality of ships are deemed to constitute a single array. For example, arrays towed by a plurality of ships are regarded as a sub-array of the single towed array.

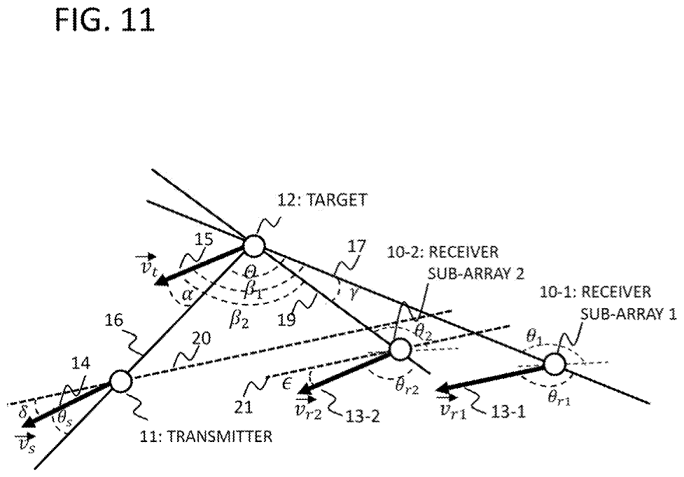

The transmitter 11 may be fixed on one of the ships having any of the receivers 10 mounted thereon, towed, or mounted on a ship dedicated to transmission. What is notable in this case is that, not only do the transmitter 11 and the receiver 10 have different velocity vectors, but also velocity vectors may differ between the sub-arrays of receivers 10, as illustrated in FIG. 11.

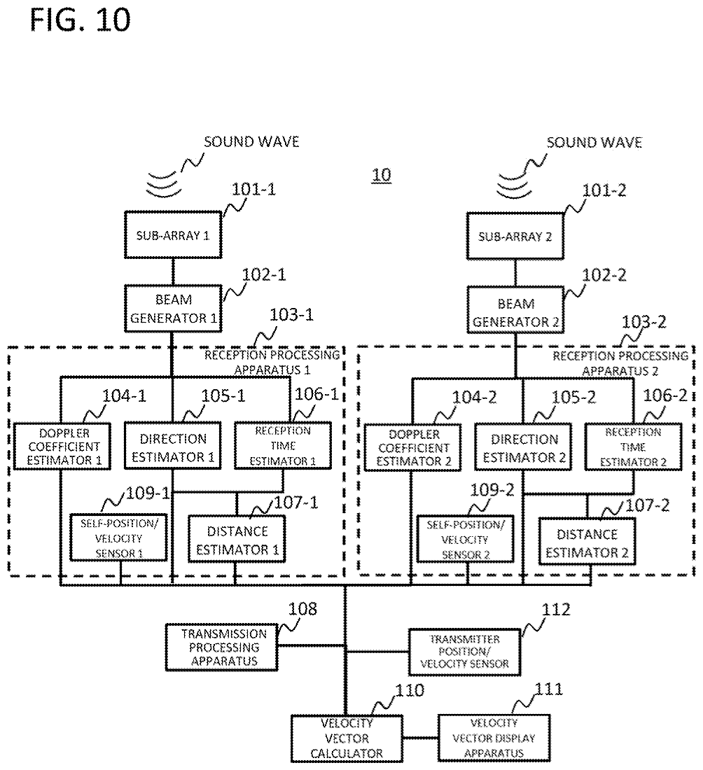

FIG. 10 is a diagram illustrating a configuration example of a third example embodiment of the present invention. In the present example embodiment, the receiver 10 is divided into two sub-arrays 101-1 and 101-2. In contrast to the configuration of the second example embodiment in which the sub-arrays have the same velocity vector, self-position/velocity sensors 109-1 and 109-2 are provided to the first and the second sub-arrays 101-1 and 101-2, respectively. Position/velocity data obtained by one of the self-position/velocity sensors 109-1 and 109-2 of the first and the second sub-arrays 101-1 and 101-2 is sent to the other sub-array via, for example, communication part, which may be a wireless LAN or optical communication if the sub-arrays are close to each other. When they are far apart, radio (wireless) or satellite communication may be used. The operation with respect to the position/velocity of the transmitter is the same as in the second example embodiment.

The following describes how the velocity vector→vₜ of the target 12 is calculated in a case where the transmitter 11 and the sub-arrays 101-1 and 101-2 all have different velocities in the present example embodiment.

Using Equation (18), the Doppler coefficient ηᵣ₁ of a signal (sound wave) received at the first sub-array 101-1 from the target is given as follows:

$${η}_{r 1} = \frac{c + {v}_{t} cos α}{c + {v}_{s} cos {θ}_{s}} \cdot \frac{c - {v}_{r 1} cos {θ}_{r 1}}{c - {v}_{t} cos {β}_{1}} \qquad ( 73 )$$

By using α=β₁−Θ, Equation (73) is transformed as follows:

{(c−vᵣ₁ cos θᵣ₁)cos Θ+ηᵣ₁(c+vₛ cos θₛ)}vₜ cos β₁+sin Θ(c−vᵣ₁ cos θᵣ₁)vₜ sin β₁=cηᵣ₁(c+vₛ cos θₛ)−c(c−vᵣ₁ cos θᵣ₁) (74)

The Doppler coefficient ηᵣ₂ of a signal (sound wave) received at the second sub-array 101-2 from the target 12 can also be given from Equation (18) as follows:

$${η}_{r 2} = \frac{c + {v}_{t} cos α}{c + {v}_{s} cos {θ}_{s}} \cdot \frac{c - {v}_{r 2} cos {θ}_{r 2}}{c - {v}_{t} cos {β}_{2}} \qquad ( 75 )$$

From

β₂=β₁−γ

α=β₁−Θ,

Equation (75) is transformed as follows:

{(c−vᵣ₂ cos θᵣ₂)cos Θ+ηᵣ₂(c+vₛ cos θₛ)cos γ}vₜ cos β₁+{(c−vᵣ₂ cos θᵣ₂)sin Θ+ηᵣ₂(c+vₛ cos θₛ)sin γ}vₜ sin β₁=cηᵣ₂(c+vₛ cos θₛ)−c(c−vᵣ₂ cos θᵣ₂) (76)

Therefore, assuming

$$A = ( \begin{matrix}\{ ( c - {v}_{r} cos {θ}_{r 1} ) cos Θ + {η}_{r 1} ( c + {v}_{s} cos {θ}_{s} ) \} & ( c - {v}_{r} cos {θ}_{r 1} ) sin Θ \\ \{ ( c - {v}_{r} cos {θ}_{r 2} ) cos Θ + {η}_{r 2} ( c + {v}_{s} cos {θ}_{s} ) cos γ \} & \{ ( c - {v}_{r} cos {θ}_{r 2} ) sin Θ + {η}_{r 2} ( c + {v}_{s} cos {θ}_{s} ) sin γ \}\end{matrix} ) \qquad ( 77 )$$

$$\vec{{v}_{t}} = ( \begin{matrix}{v}_{t} cos {β}_{1} \\ {v}_{t} sin {β}_{1}\end{matrix} ) \qquad ( 78 )$$

$$\vec{b} = ( \begin{matrix}c {η}_{r 1} ( c + {v}_{s} cos {θ}_{s} ) - c ( c - {v}_{r} cos {θ}_{r 1} ) \\ c {η}_{r 2} ( c + {v}_{s} cos {θ}_{s} ) - c ( c - {v}_{r} cos {θ}_{r 2} )\end{matrix} ) \qquad ( 79 )$$

Equation (74) and (76) can be expressed in the matrix form of Equation (80):

A·\vec{vₜ}=\vec{b} (80)

Therefore, from

\vec{vₜ}=A⁻¹·\vec{b} (81)

the velocity vector→vᵣ=(vₜ cos β₁, vₜ sin β₁) of the target 12 can be calculated. Here, the sound velocity c may be provided in advance or may be measured on the spot. vᵣ₁ and vᵣ₂ may be obtained from the self-position/velocity sensors 109-1 and 109-2 attached to the body of the ship or may be calculated from location information obtained from the GPS and the like.

In Equation (77) and (79), θᵣ₁ and θᵣ₂ are the angles formed by the velocity vectors 13-1 and 13-2 of the first and the second sub-arrays 101-1 and 101-2 and the straight lines 17 and 19 connecting the first and the second sub-arrays 101-1 and 101-2 to the target 12, respectively. Θ is the crossing angle between the straight lines 16 and 17 and can be calculated when the positions of the first sub-array 101-1, the transmitter 11, and the target 12 are found. In a case where the receiver 10 is mounted on the body of the ship, the position of the first sub-array 101-1 can be determined from the structural location thereof. In a case where the receiver 10 is towed, the position of the first sub-array 101-1 can be estimated from the structural length of the towing portion. Alternatively, a position sensor may be attached to the receiver 10, and the position of the sub-array 101-1 may be obtained from the position sensor.

As for the position and velocity of the transmitter 11, for example, data from the position/velocity sensor provided therein may be sent to the receiver via communication part as in the example embodiment described above.

The position of the target 12 can be calculated by using the target direction obtained by the direction estimator 105 and the target distance obtained by the distance estimator 107. Since γ is a difference in the target direction between the first and the second sub-arrays 101-1 and 101-2, it can be calculated from the target directions θ₁ and θ₂ obtained by the first and the second direction estimators 105-1 and 105-2 corresponding to the first and the second sub-arrays 101-1 and 101-2, respectively, as follows:

θ₁−θ₂=γ (82)

Alternatively, θ₁, θ₂, and γ may be calculated by only using the distance between the first and the second sub-arrays 101-1 and 101-2 and the target distance from each of the sub-arrays 101-1 and 101-2 without using the directions θ₁, θ₂ and γ obtained from θ₁ and θ₂, and the results may be used. This is effective when the directional accuracy suffices to be low.

Further, the approximate expression (19) may be used instead of Equation (18). In this case, the Doppler coefficient ηᵣ₁ obtained at the first sub-array 101-1 is given by the following Equation (83):

$${η}_{r 1} = 1 + \frac{{v}_{t} ( cos α + cos {β}_{1} ) - {v}_{s} cos {θ}_{s} - {v}_{r 1} cos {θ}_{r 1}}{c} \qquad ( 83 )$$

Using α=β₁−Θ,

Equation (83) is transformed as follows:

{(cos Θ+1)}vₜ cos β₁+(sin Θ)vₜ sin β₁=c(ηᵣ₁−1)+vₛ cos θₛ+vᵣ₁ cos θᵣ₁ (84)

The Doppler coefficient ηᵣ₂ obtained at the second sub-array 101-2 is given by the following Equation (85):

$${η}_{r 2} = 1 + \frac{{v}_{t} \{ cos α + cos {β}_{2} cos γ + sin {β}_{2} sin γ \} - {v}_{s} cos {θ}_{s} - {v}_{r 2} cos {θ}_{r 2}}{c} \qquad ( 85 )$$

Using

β₂=β₁−γ,

α=β₁−Θ,

Equation (85) is transformed as follows:

{(cos Θ+cos γ)}vₜ cos β₁+{(sin Θ+sin γ)}vₜ sin β₁=c(ηᵣ₂−1)+vₛ cos θₛ+vᵣ₂ cos θᵣ₂ (86)

Here, assuming

$$F = ( \begin{matrix}cos Θ + 1 & sin Θ \\ cos Θ + cos γ & sin Θ + sin γ\end{matrix} ) \qquad ( 87 )$$

$$\vec{{v}_{t}} = ( \begin{matrix}{v}_{t} cos {β}_{1} \\ {v}_{t} sin {β}_{1}\end{matrix} ) \qquad ( 88 )$$

$$and$$

$$\vec{g} = ( \begin{matrix}c ( {η}_{r 1} - 1 ) + {v}_{s} cos {θ}_{s} + {v}_{r} cos {θ}_{r 1} \\ c ( {η}_{r 2} - 1 ) + {v}_{s} cos {θ}_{s} + {v}_{r} cos {θ}_{r 2}\end{matrix} ) \qquad ( 89 )$$

then

F·\vec{vₜ}=\vec{g} (90)

and from

\vec{vₜ}=F⁻¹·\vec{g} (91)

the velocity vector→vₜ of the target 12 is calculated.

Further, although the present example described a case with two sub-arrays, there may be three or more sub-arrays as noted in the first example. In this case, for example, the velocity vectors obtained from combinations of any two sub-arrays may be averaged among the combinations. Further, velocity vectors may be calculated by using a method different from the examples described in the example embodiments.

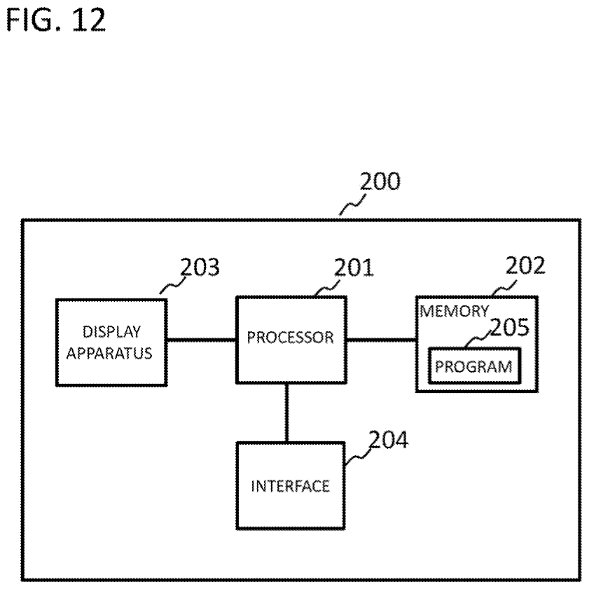

FIG. 12 is a diagram illustrating an example embodiment of the present invention and illustrating configuration when a computer apparatus 200 is implemented as a direction estimation apparatus. With reference to FIG. 12, the computer apparatus 200 includes a processor 201, a memory 202 such as a semiconductor memory such as RAM (Random Access Memory), ROM (Read-Only Memory), and EEPROM (Electrically Erasable Programmable Read-Only Memory (or HDD (Hard Disk Drive), etc.), a display apparatus 203, and an interface (bus interface) 204. The processor 201 may be a DSP (Digital Signal Processor). The processor 201 executes the processing of at least the reception processing apparatuses 103-1 and 103-2 and the velocity vector calculator 110 in FIG. 4 by executing a program 205 stored in the memory 202. The display apparatus 203 constitutes the velocity vector display apparatus 111 in FIG. 4.

In the example embodiments described above, sonar was used as an example, however, the present invention can also be applied to radar and LiDAR (Light Detection And Ranging).

Further, each disclosure of Patent Literatures 1 to 3 and Non-Patent Literatures 1 to 3 cited above is incorporated herein in its entirety by reference thereto. It is to be noted that it is possible to modify or adjust the example embodiments or examples within the whole disclosure of the present invention (including the Claims) and based on the basic technical concept thereof. Further, it is possible to variously combine or select a wide variety of the disclosed elements (including the individual elements of the individual claims, the individual elements of the individual examples and the individual elements of the individual figures) within the scope of the Claims of the present invention. That is, it is self-explanatory that the present invention includes any types of variations and modifications to be done by a skilled person according to the whole disclosure including the Claims, and the technical concept of the present invention.

What is claimed is:

1. A target velocity vector display system comprising:
a transmitter that transmits a transmission signal;
a receiver array including a plurality of receiver elements arranged in an array form, the receiver array provided at a location different from a location of the transmitter, the receiver array receiving a reflection signal from a target that reflects the transmission signal transmitted from the transmitter,
a display apparatus; and
at least one processor configured to:
virtually divide the receiver array into a plurality of sub-arrays;
calculate an individual Doppler coefficient based on movement of the target for an individual one of the plurality of sub-arrays;
calculate a velocity vector of the target, by using a plurality of the individual Doppler coefficients calculated respectively for the plurality of sub-arrays; and
display, on the display apparatus, information on the velocity vector of the target.

2. The target velocity vector display system according to claim 1, wherein the plurality of sub-arrays includes at least first and second sub-arrays, each constituting a part of the receiver array, wherein the at least one processor is configured to implement:
first and second Doppler coefficient calculation parts corresponding to the first and the second sub-arrays, the first and second Doppler coefficient calculation parts calculating first and second Doppler coefficients based on the movement of the target, respectively, from signals respectively received by the first and the second sub-arrays; and
a velocity vector calculation part that calculates the velocity vector of the target, based on simultaneous equations,
derived from a set of equations that hold among:
the first and the second Doppler coefficients;
a signal velocity;
a velocity components of the transmitter in a direction from the transmitter to the target;
a velocity component of the target in a direction from the target to the transmitter;
velocity components of the first and the second sub-arrays in respective directions from the first and the second sub-arrays to the target; and
velocity components of the target in respective directions from the target to the first and the second sub-arrays,
or derived from approximate expressions of the set of the equations.

3. The target velocity vector display system according to claim 2, wherein the at least one processor is configured to implement
the velocity vector calculation part that calculates the velocity vector of the target having a projection of the target onto a straight line connecting the first sub-array to the target as a first component and a projection the target onto a direction orthogonal to a direction of the straight line as a second component, from the simultaneous equations, by using operations on:
the first and the second Doppler coefficients;
the signal velocity;
a projection of the velocity vector of the transmitter onto a straight line connecting the transmitter to the target;
projections of the velocity vectors of the first and the second sub-arrays onto straight lines respectively connecting the first and the second sub-arrays to the target;
a crossing angle between the straight line connecting the transmitter to the target and the straight line connecting the first sub-array to the target; and
a crossing angle between the straight line connecting the first sub-array to the target and the straight line connecting the second sub-array to the target.

4. The target velocity vector display system according to claim 2, wherein the at least one processor is configured to implement
the velocity vector calculation part that calculates, as the velocity vector of the target, a value obtained by averaging the velocity vectors of the target derived from the Doppler coefficients of combinations of the first and the second sub-arrays, which are predetermined sub-array pairs out of the plurality of sub-arrays.

5. The target velocity vector display system according to claim 1, wherein each of the sub-arrays is configured by virtually dividing the receiver array of a single receiver, or
a plurality of receiver arrays are deemed to be a single receiver array and each of the receiver arrays in the single receiver array is deemed to be each of the sub-arrays.

6. A target velocity vector display method for a system including a transmitter that transmits a transmission signal; and a receiver array including a plurality of receiver elements arranged in an array form, the receiver array provided at a location different from a location of the transmitter, the receiver array receiving a reflection signal from a target that reflects the transmission signal transmitted from the transmitter, the method comprising:
virtually dividing the receiver array into a plurality of sub-arrays;
calculating an individual Doppler coefficient based on movement of the target for an individual one of the plurality of sub-arrays;
calculating a velocity vector of the target, by using a plurality of the individual Doppler coefficients calculated respectively for the plurality of sub-arrays; and
displaying, on a display apparatus, information on the velocity vector of the target.

7. The target velocity vector display method according to claim 6, comprising:
calculating first and second Doppler coefficients based on the movement of the target, respectively, from signals respectively received by the first and the second sub-arrays; and
calculating the velocity vector of the target, based on simultaneous equations,
derived from a set of equations that hold among:
the first and the second Doppler coefficients;
a signal velocity;
a velocity components of the transmitter in a direction from the transmitter to the target;
a velocity component of the target in a direction from the target to the transmitter;
velocity components of the first and the second sub-arrays in respective directions from the first and the second sub-arrays to the target; and
velocity components of the target in respective directions from the target to the first and the second sub-arrays,
or derived from approximate expressions of the set of the equations.

8. The target velocity vector display method according to claim 7, comprising:
calculating the velocity vector of the target having a projection of the target onto a straight line connecting the first sub-array to the target as a first component and a projection the target onto a direction orthogonal to a direction of the straight line as a second component, from the simultaneous equations, by using operations on:
the first and the second Doppler coefficients;
the signal velocity;
a projection of the velocity vector of the transmitter onto a straight line connecting the transmitter to the target;
projections of the velocity vectors of the first and the second sub-arrays onto straight lines respectively connecting the first and the second sub-arrays to the target;
a crossing angle between the straight line connecting the transmitter to the target and the straight line connecting the first sub-array to the target; and
a crossing angle between the straight line connecting the first sub-array to the target and the straight line connecting the second sub-array to the target.

9. The target velocity vector display method according to claim 6, comprising:
calculating, as the velocity vector of the target, a value obtained by averaging the velocity vectors of the target derived from the Doppler coefficients of combinations of the first and the second sub-arrays, which are predetermined sub-array pairs out of the plurality of sub-arrays.

10. The target velocity vector display method according to claim 6, wherein each of the sub-arrays is configured by virtually dividing the receiver array of a single receiver, or
a plurality of receiver arrays are deemed to be a single receiver array and each of the receiver arrays in the single receiver array is deemed to be each of the sub-arrays.

11. A non-transitory computer readable medium storing a program causing a computer in a system including a transmitter that transmits a transmission signal; and a receiver array including a plurality of receiver elements arranged in an array form, the receiver array provided at a location different from a location of the transmitter, the receiver array receiving a reflection signal from a target that reflects the transmission signal transmitted from the transmitter, to execute processing comprising:
virtually dividing the receiver array into a plurality of sub-arrays;
calculating an individual Doppler coefficient based on movement of the target for an individual one of the plurality of sub-arrays;
calculating a velocity vector of the target, by using a plurality of the individual Doppler coefficients calculated respectively for the plurality of sub-arrays; and
displaying, on a display apparatus, information on the velocity vector of the target.

12. The non-transitory computer readable medium according to claim 11, storing the program causing the computer to execute processing comprising:
calculating first and second Doppler coefficients based on the movement of the target, respectively, from signals respectively received by the first and the second sub-arrays; and
calculating the velocity vector of the target, based on simultaneous equations,
derived from a set of equations that hold among:
the first and the second Doppler coefficients;
a signal velocity;
a velocity components of the transmitter in a direction from the transmitter to the target;
a velocity component of the target in a direction from the target to the transmitter;
velocity components of the first and the second sub-arrays in respective directions from the first and the second sub-arrays to the target; and
velocity components of the target in respective directions from the target to the first and the second sub-arrays,
or derived from approximate expressions of the set of the equations.

13. The non-transitory computer readable medium according to claim 12, wherein the program causing the computer to execute processing comprising:
calculating the velocity vector of the target having a projection of the target onto a straight line connecting the first sub-array to the target as a first component and a projection the target onto a direction orthogonal to a direction of the straight line as a second component, from the simultaneous equations, by using operations on:
the first and the second Doppler coefficients;
the signal velocity;
a projection of the velocity vector of the transmitter onto a straight line connecting the transmitter to the target;
projections of the velocity vectors of the first and the second sub-arrays onto straight lines respectively connecting the first and the second sub-arrays to the target;
a crossing angle between the straight line connecting the transmitter to the target and the straight line connecting the first sub-array to the target; and
a crossing angle between the straight line connecting the first sub-array to the target and the straight line connecting the second sub-array to the target.

14. The non-transitory computer readable medium according to claim 11, storing the program causing the computer to execute processing comprising:
calculating, as the velocity vector of the target, a value obtained by averaging the velocity vectors of the target derived from the Doppler coefficients of combinations of the first and the second sub-arrays, which are predetermined sub-array pairs out of the plurality of sub-arrays.

15. The non-transitory computer readable medium according to claim 11, wherein each of the sub-arrays is configured by virtually dividing the receiver array of a single receiver, or
a plurality of receiver arrays are deemed to be a single receiver array and each of the receiver arrays in the single receiver array is deemed to be each of the sub-arrays.
